(19) United States
(12) Patent Application Publication
(10) Pub. No.: US 2021/0356920 A1
(43) Pub. Date: Nov. 18, 2021

(54) INFORMATION PROCESSING APPARATUS, INFORMATION PROCESSING METHOD, AND PROGRAM

(71) Applicant: SONY CORPORATION, TOKYO (JP)

(72) Inventors: SHINGO TAKAMATSU, TOKYO (JP); MASANORI MIYAHARA, TOKYO (JP); KOGA TAMAMURA, TOKYO (JP); TOMOKO TAKAHASHI, TOKYO (JP); MOTOKI HIGASHIDE, TOKYO (JP)

(21) Appl. No.: 17/286,268

(22) PCT Filed: Oct. 11, 2019
(86) PCT No.: PCT/JP2019/040171

§ 371 Date: Apr. 16, 2021

(30) Foreign Application Priority Data
Oct. 26, 2018 (JP) 2018-201499

(51) Int. Cl. G05B 13/04; G06N 20/00; G05B 13/02; G06Q 30/02; G05B 17/02

(52) U.S. Cl. CPC G05B 13/048; G06N 20/00; G05B 17/02; G06Q 30/0202; G05B 13/0265

(57) ABSTRACT

This technology relates to an information processing apparatus, an information processing method, and a program for permitting relatively easy comparison and examination of learning histories. An information processing apparatus includes a control section configured to perform control to display multiple prediction models as models trained by machine learning, and respective pieces of model information regarding the prediction models. This technology can be applied, for example, to information processing apparatuses that perform learning and prediction by machine learning.

### TECHNICAL FIELD

The present technology relates to an information processing apparatus, an information processing method, and a program. More particularly, the technology relates to an information processing apparatus, an information processing method, and a program for providing relatively easy comparison and examination of learning histories.

### BACKGROUND ART

In recent years, machine learning has been utilized in diverse fields. For example, techniques have been proposed for predicting the contract probability of real estate transactions (selling and buying) through machine learning (e.g., PTL 1).

### CITATION LIST

### Patent Literature

[PTL 1]
Japanese Patent Laid-open No. 2017-16321

### SUMMARY

### Technical Problem

To build a highly accurate prediction model for machine learning requires adjusting and learning the items for use as learning data, prediction models, and model parameters, before repeating multiple times the evaluation of the prediction model obtained through learning. Thus, in order to build the prediction model efficiently, tools are desired that provide relatively easy examination of learning histories up to that moment.

The present technology has been devised in view of the above circumstances and is aimed at providing relatively easy examination of learning histories.

### Solution to Problem

According to one aspect of the present technology, there is provided an information processing apparatus including a control section configured to perform control to display a plurality of prediction models as models trained by machine learning, and respective pieces of model information regarding the prediction models.

According to one aspect of the present technology, there is provided an information processing method including causing an information processing apparatus to perform control to display a plurality of prediction models as models trained by machine learning, and respective pieces of model information regarding the prediction models.

According to one aspect of the present technology, there is provided a program for causing a computer to function as a control section performing control to display a plurality of prediction models as models trained by machine learning, and respective pieces of model information regarding the prediction models.

According to one aspect of the present technology, control is performed to display a plurality of prediction models as models trained by machine learning, and respective pieces of model information regarding the prediction models.

It is to be noted that the information processing apparatus according to one aspect of the present technology can be implemented by getting a computer to execute a program. The program can be transmitted via a transmission medium or recorded on a recording medium when offered.

The information processing apparatus may be either an independent apparatus or an internal block constituting a single apparatus.

### BRIEF DESCRIPTION OF DRAWINGS

FIG. 1 is a block diagram depicting a configuration example of a prediction system to which the present technology is applied.

FIG. 2 is a view depicting an example of learning data sets.

FIG. 3 is a view depicting a configuration example of a history management screen.

FIG. 4 is a view depicting a configuration example of a new model creation screen.

FIG. 5 is a view depicting a configuration example of a new model detail setting screen.

FIG. 6 is a flowchart explaining an entry sorting process.

FIG. 7 is a flowchart explaining a comparability determining process.

FIG. 8 is a view depicting a configuration example of the history management screen following the entry sorting process.

FIG. 9 is a view depicting a configuration example of the history management screen in the case where a display-tree button is pressed.

FIG. 10 is a view depicting other examples of the tree representation in a history display region.

FIG. 11 is a view depicting another configuration example of the history management screen.

FIG. 12 is a view depicting a configuration example of an entry differential display screen.

FIG. 13 is a view depicting a configuration example of a suggestion screen.

FIG. 14 is a flowchart explaining a suggestion displaying process.

FIG. 15 is a view depicting an example of a differential entry.

FIG. 16 is a block diagram depicting a configuration example of a computer to which the present technology is applied.

### DESCRIPTION OF EMBODIMENTS

Preferred embodiments for implementing the present technology (referred to as the embodiment(s)) are described below. The description is made in the following order:

1. Block diagram of the prediction system
2. Configuration example of the history management screen
3. New model creating process
4. Entry sorting process
5. Tree displaying process
6. Process of displaying the presence or absence of significant difference
7. Example of entry differential display
8. Display example of the suggest function
9. Configuration example of the computer

### <1. Block Diagram of the Prediction System>

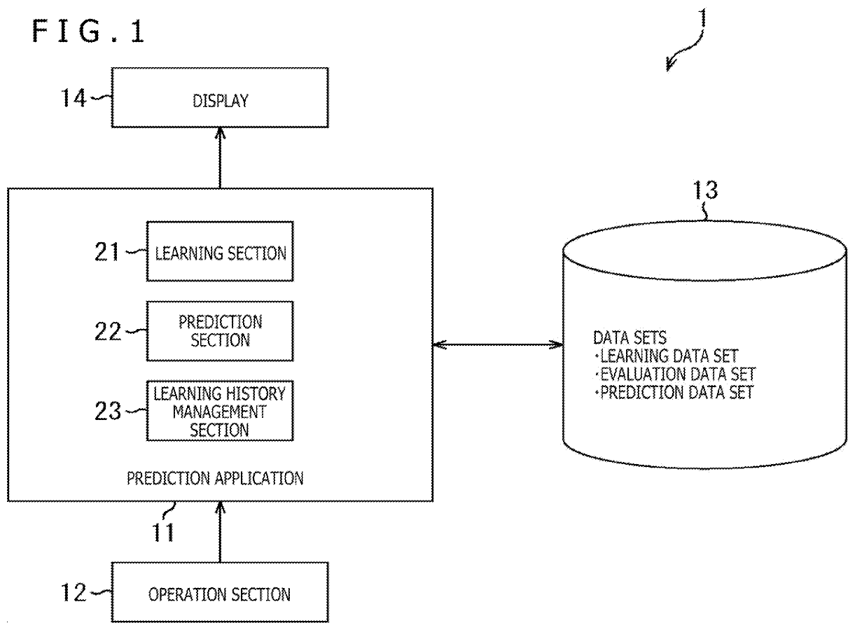

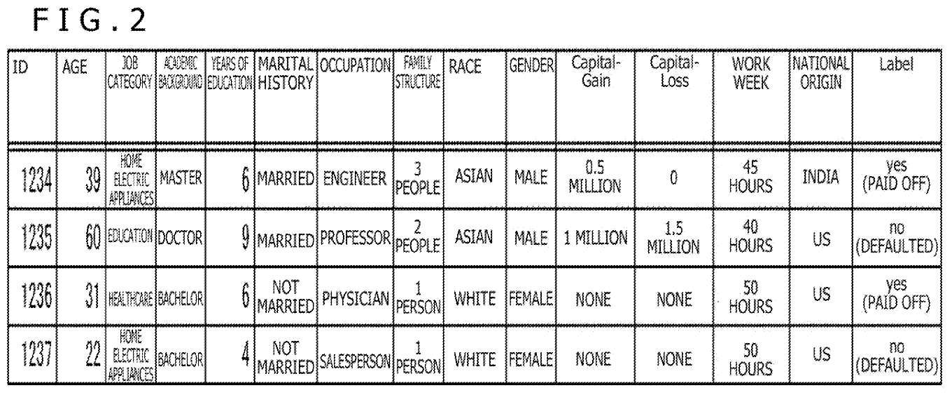

FIG. 1 is a block diagram depicting a configuration example of a prediction system to which the present technology is applied.

A prediction system 1 in FIG. 1 includes a prediction application 11, an operation section 12, a storage 13, and a display 14. This is a system that performs machine learning and, using a trained model resulting from the learning as a prediction model, predicts predetermined prediction target items.

The prediction system 1 may be configured either with a single information processing apparatus such as a personal computer, a server apparatus, or a smartphone, or with multiple information processing apparatuses interconnected via networks such as the Internet or LAN (Local Area Network) as in the case of a server-client system.

The prediction application 11 includes an application program. When executed by a CPU (Central Processing Unit) of a personal computer, for example, the prediction application 11 implements a learning section 21, a prediction section 22, and a learning history management section 23. The learning section 21, the prediction section 22, and the learning history management section 23 each provide two functions: the function as an operation control section that performs predetermined processes based on instruction operations of a user supplied from the operation section 12, and the function as a display control section that causes the display 14 to display relevant information such as learning results and prediction results.

The operation section 12 includes a keyboard, a mouse, switches, and a touch panel, for example. The operation section 12 accepts the user's instruction operations and supplies them to the prediction application 11.

The storage 13 is a data storage section that includes a recording medium such as a hard disk or a semiconductor memory for storing data sets and application programs necessary for learning and prediction. The storage 13 stores, as data sets, a learning data set for learning purposes, an evaluation data set for evaluating a prediction model obtained by learning, and a prediction data set for making predictions by use of the prediction model acquired by learning.

FIG. 2 is a view depicting an example of the learning data set.

FIG. 2 depicts a portion of a typical learning data set for use in learning a prediction model that predicts, for credit examination upon extending loans to individuals, the probabilities of such individuals defaulting on their debts based on their histories and their financial assets.

The learning data set in FIG. 2 includes, as data items (feature quantities), ID, age, job category, academic background, years of education, marital history, occupation, family structure, race, gender, capital gain, capital loss, work week, national origin, and label. The label, which is the last item in the learning data set, is the known answer to a prediction target item, “yes” indicating that the individual has paid off the debt, “no” indicting that the individual has defaulted on the debt.

Returning to FIG. 1, the display 14 is a display device such as an LCD (Liquid Crystal Display) or an organic EL (Electro-Luminescence) display that displays images supplied from the prediction application 11. For example, the display 14 displays a learning parameter setting screen for learning purposes and prediction results.

The learning section 21 of the prediction application 11 performs a learning process (machine learning) based on a predetermined learning model using the learning data set stored in the storage 13. A trained model obtained by the learning process is used by the prediction section 22 as the prediction model for predicting a predetermined prediction target item. The learning section 21 possesses a logistic regression model, a neural network model, and a random forest model, for example, as the learning models (prediction models). In accordance with the user's instruction operations, the learning section 21 selects the appropriate learning model for carrying out the learning process. Also, using the evaluation data set having known answers to the prediction target items, the learning section 21 performs an evaluation process for evaluating the accuracy of the learning model (prediction accuracy) obtained by the learning process.

The prediction section 22 performs a prediction process to predict the predetermined prediction target items using the prediction model that is a trained model obtained by the learning section 21 carrying out the learning process. The prediction process makes use of the prediction data set stored in the storage 13.

The learning history management section 23 manages the histories of multiple learning processes carried out by the learning section 21. That is, a highly accurate learning model is built by machine learning that involves repeating multiple times a learning process and the evaluation of a learning model obtained by the learning process. For example, when multiple learning processes are performed, the data items used as learning data, the learning model, learning parameters such as regularization term coefficients, and prediction target items are modified as needed to determine whether or not the accuracy of prediction is improved. There are also cases where the learning data set is updated (expanded) and the learning model is again calculated. The learning history management section 23 presents the user in an easy-to-understand manner with the details of multiple learning processes performed by the learning section 21, such as different data sets and different learning models in different learning processes, as well as accuracy evaluation index values. With this embodiment, it is assumed that the learning process or the learning also includes accuracy evaluation to be performed thereafter. The learning history management section 23 further proposes a learning model presumed to be more preferable based on comparisons between multiple learning models generated in past learning processes and on the multiple learning processes carried out in the past.

The prediction application 11 is largely characterized by a learning history management function implemented by the learning history management section 23. In the ensuing paragraphs, the details of the learning process by the learning section 21 and of the prediction process by the prediction section 22 will be omitted, and the function of the learning history management section 23 will be explained in details. It is assumed that the learning process and the prediction process are suitably carried out respectively by the learning section 21 and by the prediction section 22 using generally known techniques.

### <2. Configuration Example of the History Management Screen>

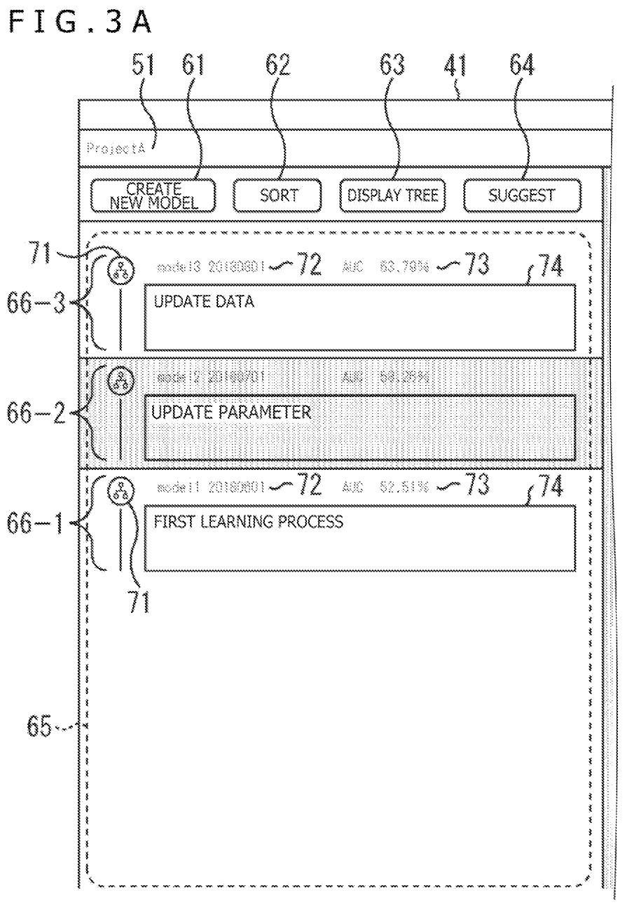

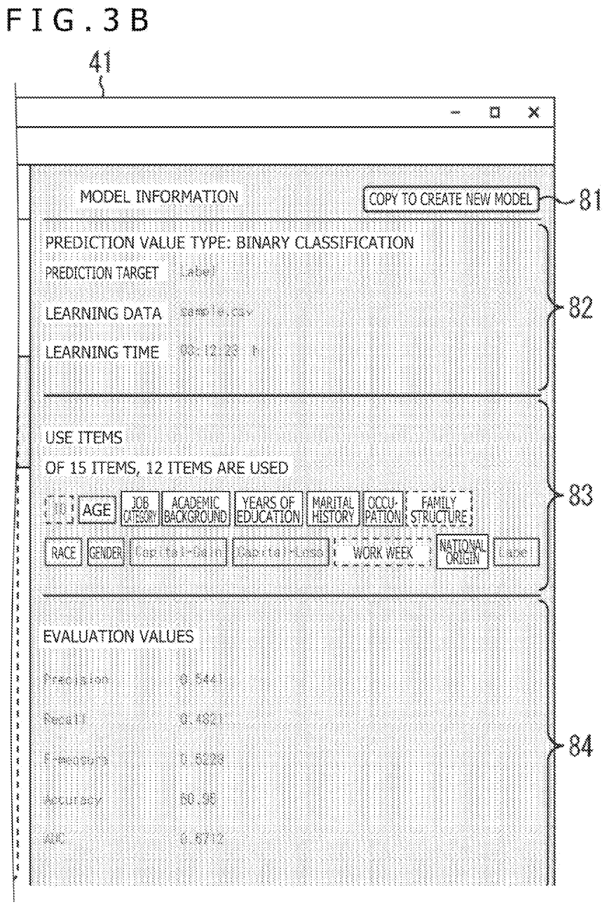

FIG. 3 depicts a configuration example of a history management screen displayed by the learning history management section 23 on the display 14.

In the case where the prediction application 11 performs the function of learning history management, the learning history management section 23 generates a history management screen 41 in FIG. 3 and causes the display 14 to display the history management screen 41 indicating multiple prediction models that are trained models obtained by the learning process and model information regarding the acquired prediction models.

The history management screen 41 in FIG. 3 is grouped into three major regions. Specifically, the history management screen 41 is divided into a project display region 51, an entry display region 52, and a summary display region 53.

The project display region 51 is displayed in an upper part of the history management screen 41. The area under the project display region 51 is bisected into a left part and a right part. The entry display region 52 is arranged in the left part, and the summary display region 53 is arranged in the right part.

The learning history management section 23 manages learning histories in units of projects. The project display region 51 displays the current project indicated by the history management screen 41. In the example of FIG. 3, an indication “Project A” appears in the project display region 51. This means the project display region 51 displays the project named “Project A.” In the ensuing description, it is assumed that “Project A” is a project for learning and predicting a prediction model that predicts debt default probabilities using the data sets such as those depicted in FIG. 2.

The entry display region 52 has buttons and a history display region 65 arranged therein, the buttons including a create-new-model button 61, a sort button 62, a display-tree button 63, and a suggest button 64. The history display region 65 displays a history (list) of learning processes previously performed by the current project being displayed (“Project A” in the example of FIG. 3).

In the history display region 65, one entry 66 is created for one learning process and displayed. The history display region 65 in FIG. 3 displays three entries 66-1 to 66-3 in chronological order, indicating that three learning processes have been carried out up to the present time.

In the history display region 65, multiple entries 66 can be arranged in the order in which they are created, for example. In this case, the most recent entry 66 is displayed in the top part of the history display region 65. Of the three entries 66-1 to 66-3 of the history display region 65 in the example of FIG. 3, the entry 66-3 is the latest, and the entry 66-1 is the oldest.

Alternatively, in the history display region 65, multiple entries 66 can be arranged in descending order of prediction accuracy evaluation values. In this case, the entry 66 with the highest evaluation value of prediction accuracy is displayed in the top part of the history display region 65. Of the three entries 66-1 to 66-3 of the history display region 65 in the example of FIG. 3, the entry 66-3 has the highest evaluation value, and the entry 66-1 has the lowest.

The method of arranging multiple entries 66 in the history display region 65 can alternatively be changed as designated by the user using, for example, a pull-down list of multiple options such as chronological order and descending order of evaluation values.

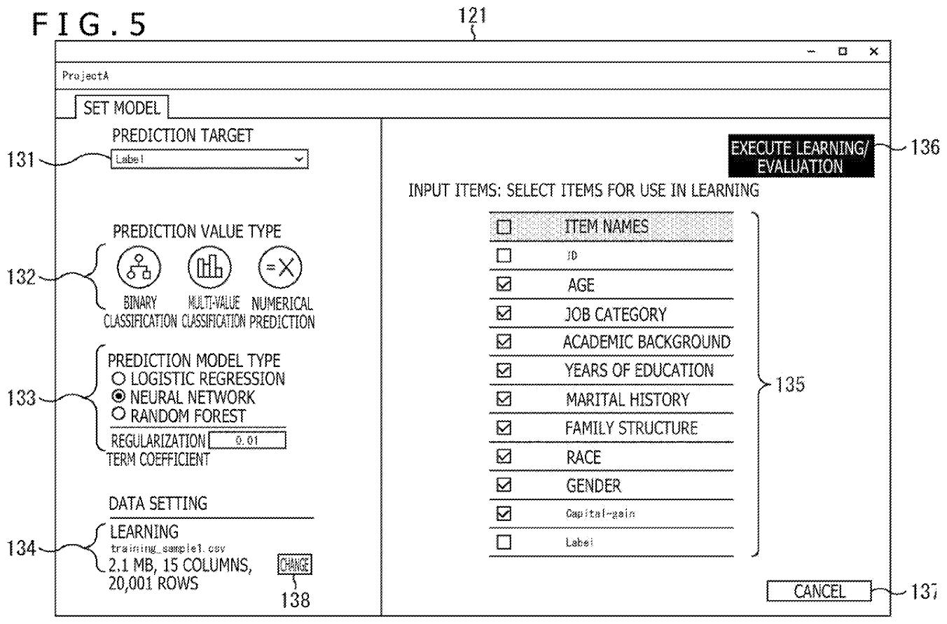

Each entry 66 displayed in the history display region 65 includes icons 71, a model name display part 72, an accuracy display part 73, and a comment display part 74. The icons 71 represent prediction value types of the prediction models learned in the entries 66. The marks displayed as the icons 71 correspond to three kinds of marks indicated in a prediction value type setting part 132 on a new model detail setting screen 121 in FIG. 5, to be discussed later.

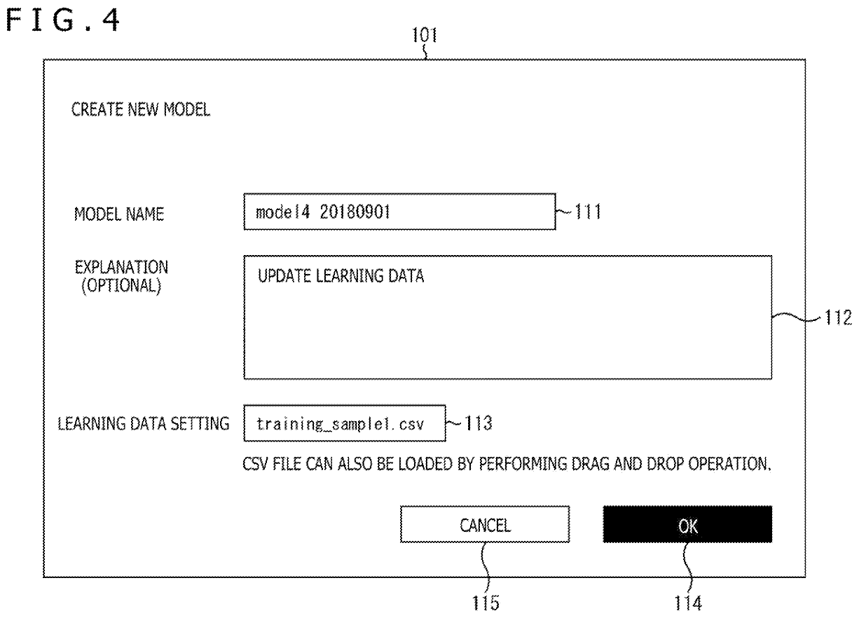

The model name display part 72 displays the name of the prediction model of the entry 66. The name displayed in the model name display part 72 is determined by the user's input to a create-new-model screen 101 in FIG. 4. The accuracy display part 73 displays the evaluation result of prediction accuracy regarding the prediction model of the entry 66. The evaluation result of prediction accuracy is given by AUC (Area Under the Curve), for example. The comment display part 74 displays a comment on the prediction model of the entry 66. The comment is displayed in the case where it is input by the user to the create-new-model screen 101 in FIG. 4.

Of the multiple entries 66 displayed in the history display region 65, the entry 66 selected (referred to as the selected entry hereunder) by the user with a mouse, for example, is displayed in a manner distinguished typically by color. Detailed information regarding the selected entry is displayed in the summary display region 53 on the right. In the example of FIG. 3, of the three entries 66-1 to 66-3, the entry 66-2 in the middle is displayed in gray, which indicates the selected state. The method of indicating the selected entry is not limited to the display in gray as in FIG. 3. Any other suitable method of indication can be adopted.

The create-new-model button 61 is pressed to create a new prediction model. Pressing the create-new-model button 61 causes the create-new-model screen 101 in FIG. 4 to appear. The processing in the case where the create-new-model button 61 is pressed will be discussed later.

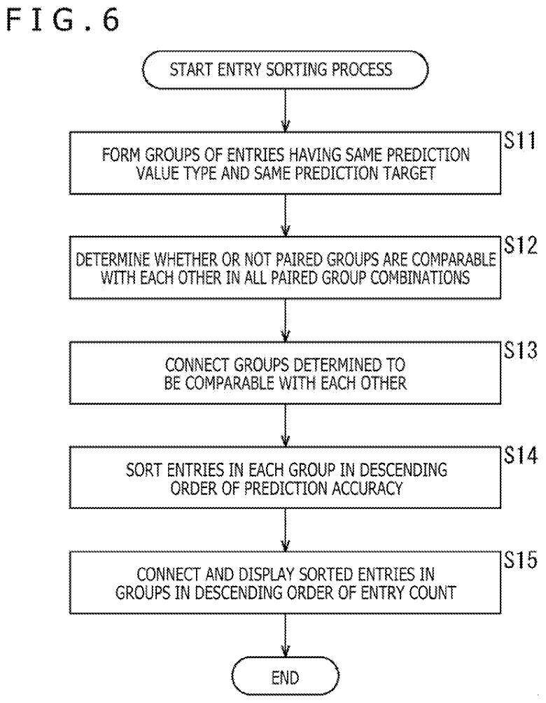

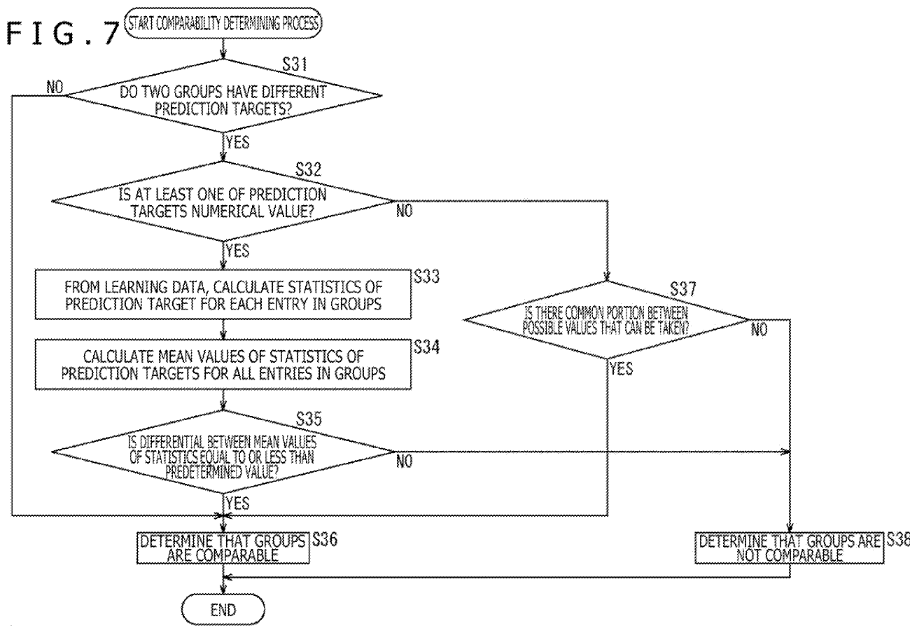

The sort button 62 is pressed to display the multiple entries 66 in the history display region 65 in a manner sorted in descending order of prediction accuracy in place of the chronological order display. Pressing the sort button 62 executes an entry sorting process, to be discussed later with reference to FIG. 6.

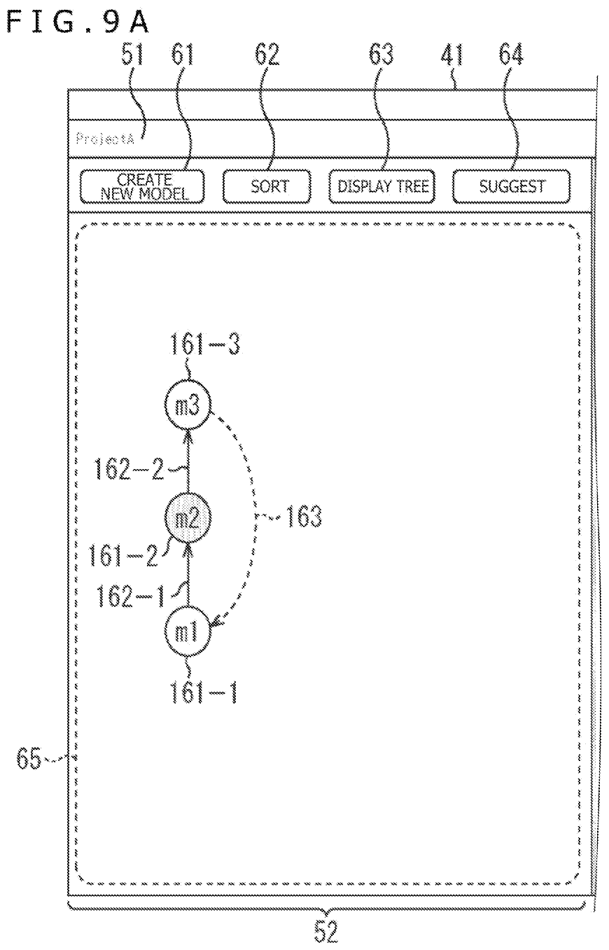

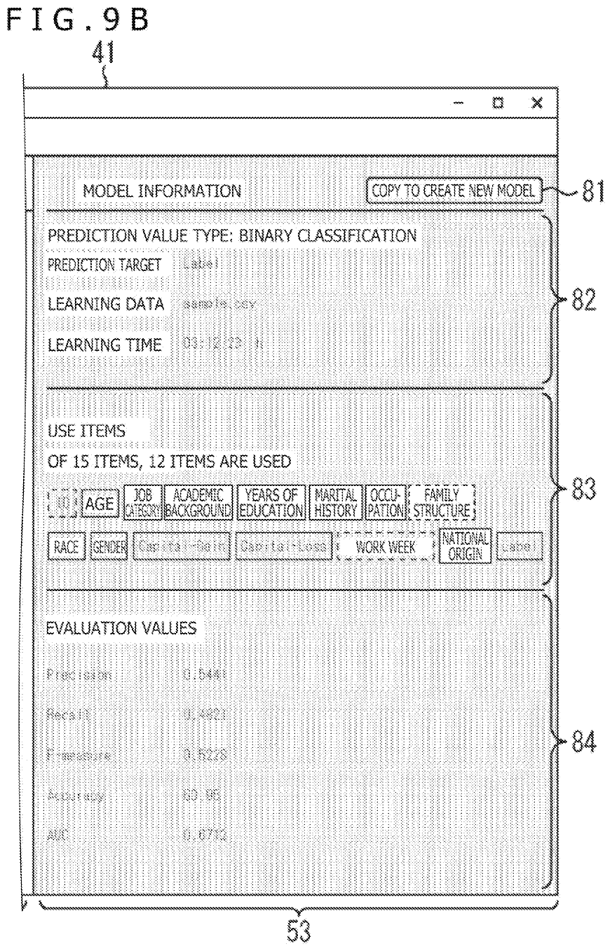

The display-tree button 63 is pressed to change, in the history display region 65, from the display including the icons 71, the model name display part 72, the accuracy display part 73, and the comment display part 74 in FIG. 3 to a tree representation. Pressing the display-tree button 63 switches the display in the history display region 65 to the tree representation, to be discussed later with reference to FIG. 9.

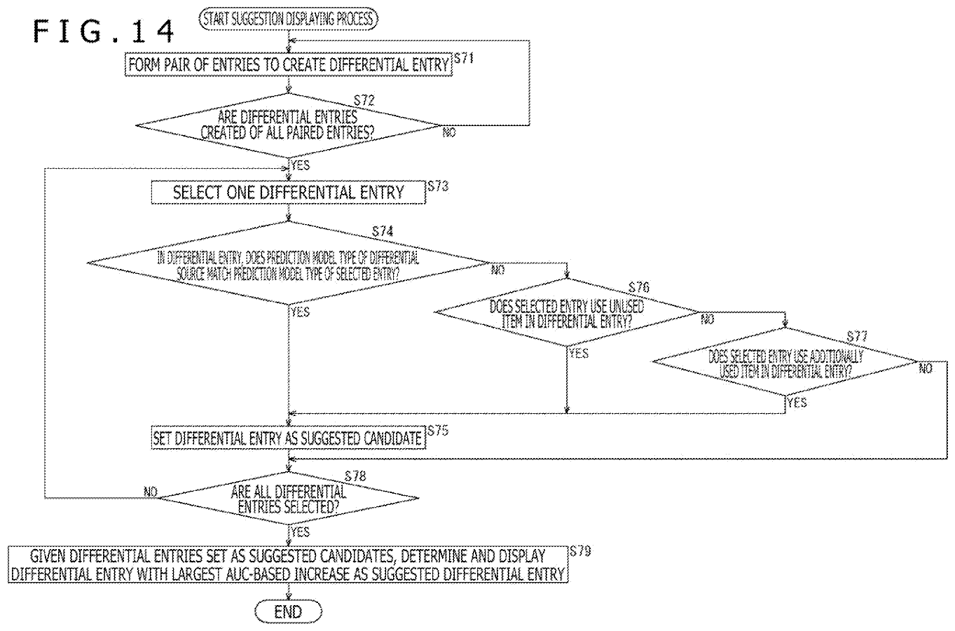

The suggest button 64 is pressed to perform a suggestion displaying process. The suggestion displaying process involves the learning history management section 23 suggesting to the user a prediction model presumed to be more preferable on the basis of multiple learning processes carried out in the past. When the suggestion displaying process is to be carried out, one of the multiple entries 66 displayed in the history display region 65 is selected with the mouse, and then the suggest button 64 is pressed. Alternatively, one of the multiple entries 66 can be selected with the mouse and, from a menu displayed by right-clicking the mouse, a “Suggest” option is selected to execute the suggestion displaying process. The suggestion displaying process will be discussed later in detail with reference to FIG. 14 and other drawings.

The summary display region 53 to the right on the history management screen 41 includes a copy-to-create-anew button 81, a basic information display region 82, a use item display region 83, and an accuracy evaluation value display region 84. The items displayed in the basic information display region 82, the use item display region 83, and the accuracy evaluation value display region 84 are detail items that identify the model information regarding the prediction model.

The copy-to-create-anew button 81 is pressed to make learning settings for a new prediction model based on the selected entry 66 currently chosen (with the model name “model 2 20180701”) in the entry display region 52. Using the function of the copy-to-create-anew button 81 makes it possible to inherit the learning settings of the selected entry for easy learning.

The basic information display region 82 displays basic information regarding the selected entry. Specifically, the basic information display region 82 displays a prediction value type, a prediction target, learning data, and learning time. The prediction value type indicates the type of the prediction values established by learning setting. The prediction value type may be any of binary classification, multi-value classification, and numerical prediction. The prediction target indicates the prediction target item established by learning setting. The learning data indicates the file name of the data set used for learning. The learning time indicates the time required for the learning process.

The use item display region 83 displays the data items included in the learning data (learning data set) of the prediction model of the selected entry, and those of the data items that are used for learning. The data items displayed in the use item display region 83 indicate the data items included in the learning data. The data items enclosed by solid-line frames are the data items used for learning, and the data items enclosed by dashed-line frame are the data items not used for learning. The method of indicating whether a data item has been used or not is not limited to the above-described method. Alternatively, the data items having been used or not may be indicated by use of different colors, for example.

The accuracy evaluation value display region 84 displays the result of evaluation (evaluation value) of the prediction accuracy regarding the prediction model of the selected entry. The evaluation indexes of prediction accuracy that are displayed include Precision (matching rate), Recall (recall rate), F-measure (F value), Accuracy (total accuracy rate), AUC (area under the ROC curve), and the like.

In the history management screen 41 in FIG. 3, multiple trained prediction models are displayed in the entry display region 52. The summary display region 53 displays model information regarding a predetermined prediction model (entry 66) selected from among these multiple prediction models. This allows the user to comparatively examine the histories of learning in a relatively easy manner.

### <3. New Model Creating Process>

Explained next is a new model creating process executed in the case where the create-new-model button 61 is pressed on the history management screen 41 in FIG. 3.

FIG. 4 depicts an example of a new model creation screen displayed in the case where the create-new-model button 61 is pressed.

On the create-new-model screen 101 in FIG. 4, it is possible to input a model name of and an explanatory comment on a newly created model (learning model) and to designate learning data. A model name of the newly created prediction model is input to a text box 111. The name input to the text box 111 is displayed in the model name display part 72 on the history management screen 41. An explanatory comment on the newly created prediction model is input to a text box 112. The explanatory comment input to the text box 112 is displayed in the comment display part 74 on the history management screen 41. A file name of the file for use as the learning data is input to a file setting part 113. The file may be input by getting a dialog displayed for file reference and, from the displayed dialog, designating the file for use as the learning data.

Pressing an OK button 114 displays the new model detail setting screen 121 depicted in FIG. 5. Pressing a cancel button 115 cancels (stops) the new model creating process.

FIG. 5 depicts an example of the new model detail setting screen displayed in the case where the OK button 114 is pressed on the create-new-model screen 101 in FIG. 4.

The new model detail setting screen 121 in FIG. 5 includes a prediction target setting part 131, a prediction value type setting part 132, a model type setting part 133, a learning data setting part 134, a data item setting part 135, an execute-learning/evaluation button 136, and a cancel button 137.

In the prediction target setting part 131, the user can set a prediction target using a pull-down list. The prediction target refers to the data item targeted for prediction from among the data items included in the learning data. The pull-down list displays the data items included in the learning data designated in the file setting part 113 on the create-new-model screen 101 in FIG. 4. Of the typical items of the learning data set depicted in FIG. 2, the item “Label” is selected from the pull-down list in FIG. 5 as the prediction target item.

In the prediction value type setting part 132, binary classification, multi-value classification, or numerical prediction can be set as the prediction value type of the prediction target item. Three kinds of marks correspond to the icons 71 of the entries 66 displayed in the entry display region 52 on the history management screen 41 in FIG. 3. The user sets the prediction value type by selecting any one of the marks that represent binary classification, multi-value classification, and numerical prediction.

In the model type setting part 133, the model type of the prediction model (learning model) for use in learning can be selected by use of a radio button. As the prediction model type, any one of the optional models of logistic regression, neural network, and random forest can be selected. Also, a normalization item coefficient can be set to prevent over-training.

The learning data setting part 134 displays the file designated as the learning data in the file setting part 113 on the create-new-model screen 101 in FIG. 4. Pressing a change button 138 displays a file reference dialog that allows the file to be changed as needed. In a prediction accuracy evaluating process carried out after the learning of the prediction model, part of the learning data is divided, for example, into evaluation data (evaluation data sets) and utilized.

The data item setting part 135 displays all data items included in the learning data set that is designated as the learning data. Given all the data items displayed, the user checks the check boxes of the data items for use as the learning data and thereby designates the data items to be used as the learning data. It is to be noted that the data item selected as the prediction target item in the prediction target setting part 131 cannot be designated here.

The execute-learning/evaluation button 136 is pressed to start a learning process and an accuracy evaluating process. The cancel button 137 is pressed to cancel (stop) the new model creating process.

In the case where the create-new-model button 61 is pressed on the history management screen 41 in FIG. 3, necessary setting items are determined successively on the create-new-model screen 101 in FIG. 4 and on the new model detail setting screen 121 in FIG. 5. Pressing the execute-learning/evaluation button 136 carries out the learning process and the prediction accuracy evaluating process.

### <4. Entry Sorting Process>

Explained next with reference to FIGS. 6 and 7 is the entry sorting process carried out in the case where the sort button 62 is pressed on the history management screen 41 in FIG. 3.

In the case where the sort button 62 is pressed on the history management screen 41 in FIG. 3, the learning history management section 23 performs the entry sorting process indicated in the flowchart of FIG. 6 so as to change the display of the multiple entries 66 in the history display region 65.

First, in step S11 of the entry sorting process in FIG. 6, the learning history management section 23 forms groups of entries having the same prediction value type and the same prediction target out of all entries included in the current project “Project A.” Thus, in the formation of the groups, the differences of the learning data are ignored.

In step S12, the learning history management section 23 forms a pair of groups, by selecting predetermined two groups, from one or more groups having been created, and performs a comparability determining process to determine whether or not the paired groups are comparable with each other. The learning history management section 23 further performs the comparability determining process on all pairs of groups to determine whether or not the paired groups are comparable with each other.

Explained here with reference to the flowchart in FIG. 7 is the comparability determining process carried out in step S12 on the paired groups. Since the entries having the same prediction value type and the same prediction target constitute one group, the two groups being paired are aggregates of the entries of which at least either the prediction value type or the prediction target is different.

In step S31, the learning history management section 23 determines whether the paired groups have different prediction targets. In the case where it is determined in step S31 that the prediction target is not different between the paired groups, i.e., that the paired groups have the same prediction target, control is transferred to step S36 to be discussed later.

On the other hand, in the case where it is determined in step S31 that the paired groups have different prediction targets, control is transferred to step S32. The learning history management section 23 then determines whether at least one of the prediction targets of the two groups is a numerical value.

In the case where it is determined in step S32 that at least one of the prediction targets of the two groups is a numerical value, control is transferred to step S33. On the other hand, in the case where it is determined that neither of the prediction targets of the two groups is a numerical value, i.e., that the prediction targets of the two groups are both categorical, control is transferred to step S37.

In step S33, which follows the above-described case in step S32 where at least either of the prediction targets is determined to be a numerical value, the learning history management section 23 calculates statistics of the prediction target for each entry in each of the two groups. The statistics of the prediction target calculated here include a mean value, a median value, a standard deviation, a maximum value, and a minimum value, for example.

Next in step S34, the learning history management section 23 calculates mean values of the statistics of the prediction targets for all entries in each of the two groups. That is, mean values for the groups are calculated of the statistics of the prediction targets for the entries calculated in step S33. For example, the mean values of the prediction targets for the entries in each group are further averaged for the entire groups. The similar calculation applies to the other statistics such as the median value, the standard deviation, the maximum value, and the minimum value.

Then, in step S35, the learning history management section 23 determines whether the differential between the mean values of each statistic in the two groups is equal to or less than a predetermined value. In the case where it is determined in step S35 that the differential between the mean values of each statistic in the two groups is equal to or less than the predetermined value, control is transferred to step S36. On the other hand, in the case where it is determined in step S35 that the differential between the mean values of each statistic in the two groups is larger than the predetermined value, control is transferred to step S38.

Meanwhile, in step S37, which follows the above-described case in step S32 where the prediction targets of the two groups are determined to be both categorical, the learning history management section 23 determines whether there is a common portion between the possible values that can be taken by the prediction targets of the two groups. In the case where it is determined in step S37 that there exists a common portion between the possible values that can be taken by the prediction targets of the two groups, control is transferred to step S36. On the other hand, in the case where it is determined in step S37 that there is no common portion between the possible values that can be taken by the prediction targets of the two groups, control is transferred to step S38.

In step S36, the learning history management section 23 determines that the paired groups are comparable with each other, and terminates the comparability determining process. The processing of step S36 is carried out in the case where the paired groups are determined to have the same prediction target in step S31, where the differential between the mean values of each statistic in the two groups is determined to be equal to or less than the predetermined value in step S35, or where there is determined to be a common portion between the possible values that can be taken by the prediction targets of the two groups in step S37. Thus, the paired groups are determined to be comparable with each other in the case where the paired groups are determined to have the same prediction target, where the differential between the mean values of each statistic in the two groups is determined to be equal to or less than the predetermined value, or where there is determined to be a common portion between the possible values that can be taken by the prediction targets of the two groups of which the prediction targets are categorical.

On the other hand, in step S38, the learning history management section 23 determines that the paired groups are not comparable with each other, and terminates the comparability determining process. The processing of step S38 is carried out in the case where the differential between the mean values of each statistic in the two groups is determined to be larger than the predetermined value in step S35 or where there is determined to be no common portion between the possible values that can be taken by the prediction targets of the two groups in step S37. Thus, the paired groups are determined to be not comparable with each other in the case where the differential between the mean values of each statistic in the two groups is determined to be larger than the predetermined value or where there is determined to be no common portion between the possible values that can be taken by the prediction targets of the two groups.

Returning to the explanation of the flowchart in FIG. 6, in step S12, the comparability determining process discussed above with reference to FIG. 7 is performed on all paired group combinations.

There is a case where the learning settings in which the prediction target is a numerical value and the prediction value type is numerical prediction are learned as the prediction value type for multi-value classification. For example, there may be a case where the prediction target that can take values ranging from 0 to 50 is learned for a multi-value classification with five categories, e.g., from 0 to 10, from 11 to 20, from 21 to 30, from 31 to 40, and from 41 to 50. Even in such a case where the prediction value types are different, the median values of the five categories can be used for numerical prediction, with evaluation values calculated by use of numerical prediction indexes. Thus, the groups can be determined to be comparable with each other by the comparability determining process.

Further, there is a case in which, given the same prediction target, the level of abstraction of the prediction target is nevertheless changed. For example, in the case where the prediction target involves predicting whether to “continue” or “withdraw from” a contract, either a binary classification of “continuance” or “withdrawal” can be adopted, or a three-valued classification of “continuation,” “contract expiration,” or “mid-contract cancellation” can be used for the prediction target. In the case where the level of abstraction (the number of categories) of the prediction target is changed in this manner, the evaluation value can be calculated as a binary classification of either the common value (“continuation” in the above example) or some other value. Thus, the groups can be determined to be comparable with each other by the comparability determining process.

In step S13, which follows step S12 in FIG. 6, the learning history management section 23 connects the groups determined to be comparable with each other.

In step S14, the learning history management section 23 sorts the entries in each of the groups in descending order of prediction accuracy.

In step S15, the learning history management section 23 connects the sorted entries in each group in descending order of entry count (the number of prediction models), displays the sorted entries in the entry display region 52 on the history management screen 41 in FIG. 3, and terminates the entry sorting process.

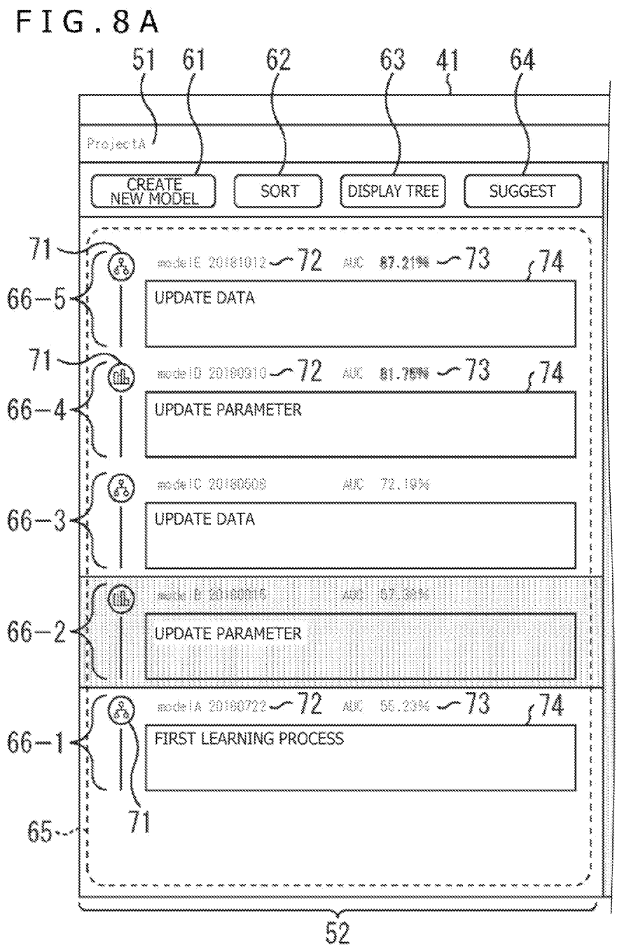

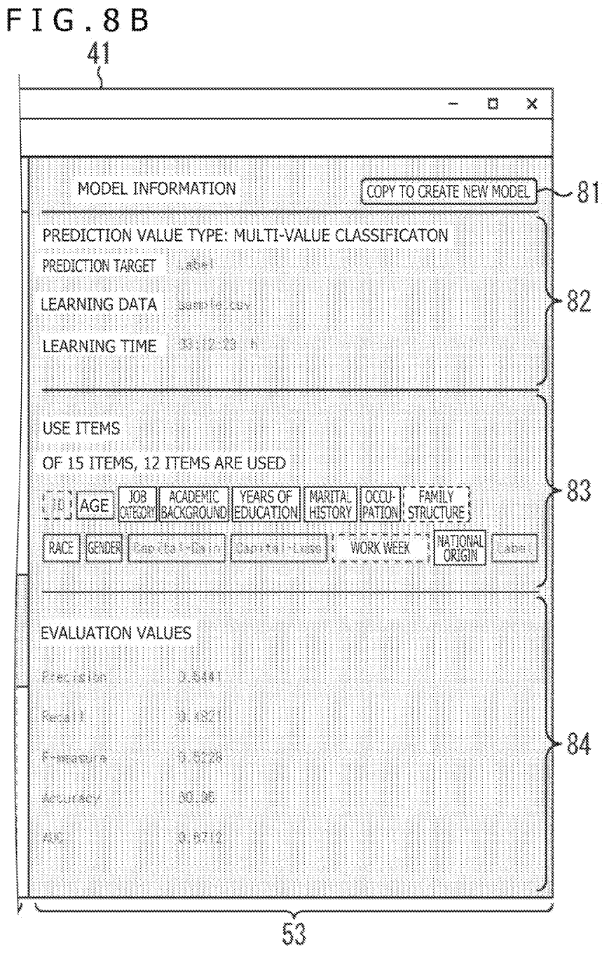

FIG. 8 depicts a typical history management screen following the entry sorting process.

On the history management screen in FIG. 3, five entries 66-1 to 66-5 are displayed in descending order of prediction accuracy evaluation values in the history display region 65.

Of the five entries 66-1 to 66-5 displayed in the history display region 65, the entries 66-1, 66-3 and 66-5 have the icons 71 indicating binary classification; and the entries 66-2 and 66-4 have the icons 71 indicating multi-value classification. Thus, the history management screen in FIG. 8 is a screen that displays the sorted multiple entries of different prediction value types.

Of the five entries 66-1 to 66-5 in the example of FIG. 8, the entry 66-2 is the selected entry chosen by the user. Detailed information regarding the selected entry 66-2 is displayed in the summary display region 53 on the right.

According to the entry sorting process, the entries having the same prediction target and the same prediction value type but with different learning data are displayed parallelly as constituting one group. The entries having different prediction targets in different groups are displayed in the entry display region 52 in order of groups having decreasing numbers of entries, with the entries in the same group being displayed in descending order of prediction accuracy.

It is to be noted that, in the entry sorting process, the evaluation values of different prediction value types may be converted to evaluation indexes common to all prediction value types, such as five-grade evaluation indexes for sorted display reflecting common evaluation values. In this case, all entries are comparable in terms of common evaluation indexes. This eliminates the need for the comparability determining process in step S12 and for the connecting process in step S13 in which the comparable groups are connected with one another.

### <5. Tree Displaying Process>

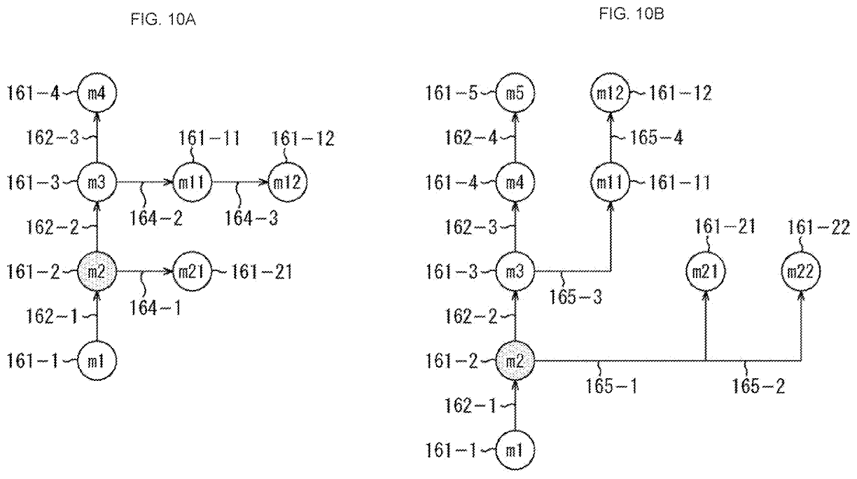

Explained next with reference to FIGS. 9 and 10 is a tree displaying process carried out in the case where the display-tree button 63 is pressed on the history management screen 41 in FIG. 3.

In the case where the display-tree button 63 is pressed, the learning history management section 23 changes to tree representation the history display region 65 on the history management screen 41 depicted in FIG. 3.

FIG. 9 depicts a typical history management screen in the case where the display-tree button 63 is pressed.

On the history management screen 41 in FIG. 9, only the history display region 65 is different from its counterpart on the history management screen 41 in FIG. 3. Thus, the regions except for the history display region 65 on the history management screen 41 will not be explained further.

In the history display region 65, each entry 66 is denoted by a circular node 161, with the nodes 161 displayed as connected by solid node interconnection lines 162 in a node representation. Displayed inside each circular node 161 are characters corresponding to the name of the prediction model of the entry 66, such as two characters abbreviating the prediction model name of the entry 66. Arrows attached to the solid node interconnection lines 162 correspond to the time series in which the entries 66 of the nodes 161 are created. In the example of FIG. 9, a solid node interconnection line 162-1 is connected from a node 161-1 of a prediction model “m1” (prediction model mode 1) to a node 161-2 of a prediction model “m2” (prediction model mode 2). A solid node interconnection line 162-2 is connected from the node 161-2 of the prediction model “m2” (prediction model mode 2) to a node 161-3 of a prediction model “m3” (prediction model mode 3). This means that the entries 66 are created chronologically starting from the prediction model “m1” (prediction model mode 1), followed by the prediction model “m2” (prediction model mode 2) and the prediction model “m3” (prediction model mode 3), in that order.

In the tree representation of FIG. 9, the node 161-2 of the prediction model “m2” is displayed in gray, which indicates the selected state. The nodes 161-1 and 161-3 of the unselected prediction models “m1” and “m3” are displayed in white.

Further, in the tree representation of FIG. 9, a dashed copy node interconnection line 163 is displayed from the node 161-3 of the prediction model “m3” to the node 161-1 of the prediction model “m1.” The dashed copy node interconnection line 163 indicates that the entry 66 of the prediction model “m3” of the connection source node 161-3 has been created on the basis of the entry 66 of the prediction model “m1” of the connection destination node 161-1. In other words, this dashed copy node interconnection line 163 is displayed in the case in which, while the entry 66 of the prediction model “m1” of the connection destination node 161-1 is chosen by the user as the selected entry, the copy-to-create-anew button 81 is pressed to learn a new prediction model.

As described above, in the case where the display-tree button 63 is pressed, the tree representation displayed in the history display region 65 provides easy visual recognition of both the order in which the entries 66 have been performed in the same project and the source entry 66 in the case where a new prediction model has been learned by pressing the copy-to-create-anew button 81.

The form of the tree representation in the history display region 65 explained above with reference to FIG. 9 may be replaced with other forms such as those in Subfigures A and B in FIG. 10.

Subfigures A and B in FIG. 10 depict other forms of the tree representation in the history display region 65 in the case where the display-tree button 63 is pressed.

In the forms of the tree representation in Subfigures A and B in FIG. 10, what is different from the representation form in FIG. 9 is the manner in which the copy source and the copy destination are interconnected in a case where the copy-to-create-anew button 81 is pressed to set the learning of a new prediction model.

In FIG. 9, the node 161 of the entry 66 as the copy source and the node 161 of the entry 66 as the copy destination are interconnected by an arrowed dashed line (the copy node interconnection line 163). By contrast, in Subfigure A of FIG. 10, the node 161 of the entry 66 as the copy destination is arranged on the right of the node 161 of the entry 66 as the copy source, the two nodes being interconnected by a solid copy node interconnection line 164.

In Subfigure A of FIG. 10, a node 161-21 of a prediction model “m21” is arranged on the right of the node 161-2 of the prediction model “m2,” the nodes being interconnected by a solid copy node interconnection line 164-1. This indicates that the node 161-21 of the prediction model “m21” is the entry 66 in the case where the copy-to-create-anew button 81 is pressed to learn a new prediction model based on the node 161-2 of the prediction model “m2.”

Also, a node 161-11 of a prediction model “m11” is arranged on the right of the node 161-3 of the prediction model “m3,” the nodes being interconnected by a solid copy node interconnection line 164-2. This indicates that the node 161-11 of the prediction model “m11” is the entry 66 in the case where the copy-to-create-anew button 81 is pressed to learn a new prediction model based on the node 161-3 of the prediction model “m3.”

Further, a node 161-12 of a prediction model “m12” is arranged on the right of the node 161-3 of the prediction model “m3” and on the right of the node 161-11 of the prediction model “m11,” the node 161-12 being connected with the node 161-11 of the prediction model “m11” by a solid copy node interconnection line 164-3. This indicates that the node 161-12 of the prediction model “m12” is the entry 66 in the case where the copy-to-create-anew button 81 is pressed to learn a new prediction model based either on the node 161-3 of the prediction model “m3” or on the node 161-11 of the prediction model “11.”

On the other hand, in Subfigure B of FIG. 10, the node 161-21 of the prediction model “m21” is connected with the node 161-2 of the prediction model “m2” by a solid copy node interconnection line 165-1 drawn from the node 161-2 to the right before being bent perpendicularly upward in an L-shape. This indicates that the node 161-21 of the prediction model “m21” is the entry 66 in the case where the copy-to-create-anew button 81 is pressed to learn a new prediction model based on the node 161-2 of the prediction model “m2.”

Also, a node 161-22 of a prediction model “m22” is connected with the node 161-2 of the prediction model “m2” by a solid copy node interconnection line 165-2 drawn from the node 161-2 to the right to extend beyond the node 161-21 of the prediction model “m21,” before being bent perpendicularly upward in an L-shape. This indicates that the node 161-22 of the prediction model “m22” is the entry 66 in the case where the copy-to-create-anew button 81 is pressed to learn a new prediction model based on the node 161-2 of the prediction model “m2.”

Further, in Subfigure B of FIG. 10, the node 161-11 of the prediction model “m11” is connected with the node 161-3 of the prediction model “m3” by a solid copy node interconnection line 165-3 drawn from the node 161-3 to the right before being bent perpendicularly upward in an L-shape. This indicates that the node 161-11 of the prediction model “m11” is the entry 66 in the case where the copy-to-create-anew button 81 is pressed to learn a new prediction model based on the node 161-3 of the prediction model “m3.”

Also, the node 161-12 of the prediction model “m12” is placed above the node 161-11 of the prediction model “m11,” the two nodes being interconnected by a solid copy node interconnection line 165-4. This indicates that the node 161-12 of the prediction model “m12” is the entry 66 in the case where the copy-to-create-anew button 81 is pressed to learn a new prediction model based on the node 161-11 of the prediction model “m11.”

In the case where the tree representation forms depicted in Subfigures A and B of FIG. 10 are adopted, it is still possible to provide easy visual recognition of both the order in which the entries 66 have been performed in the same project and the source entry 66 in the case where a new prediction model has been learned by pressing the copy-to-create-anew button 81.

Furthermore, when the tree representation is formed in a manner making a distinction between the entry 66 created by copying an existing prediction model and the entry 66 created without copying any existing prediction model, it is possible to display, in an easy-to-understand way, the entries 66 created by copying existing prediction models.

### <6. Process of Displaying the Presence or Absence of Significant Difference>

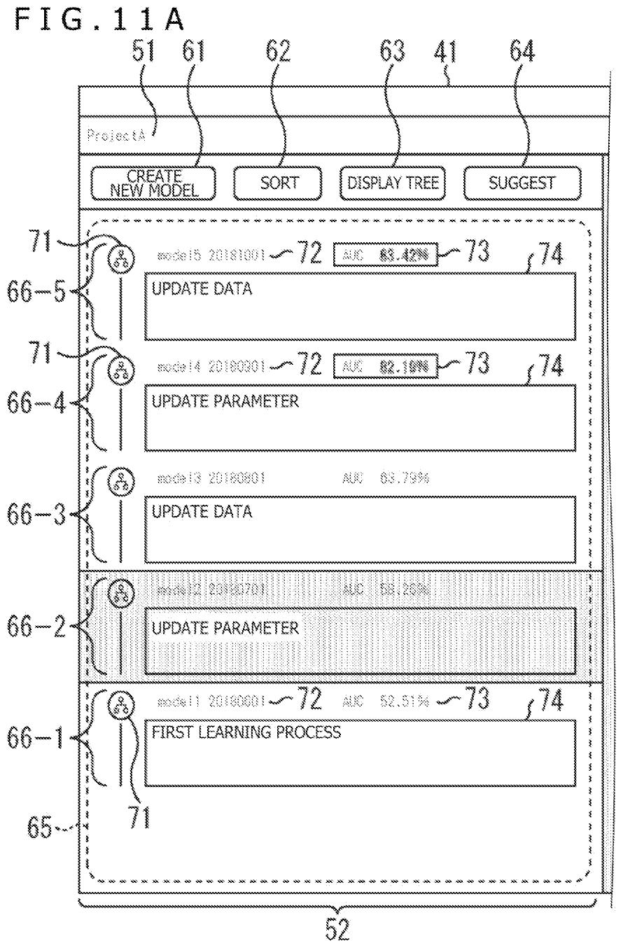

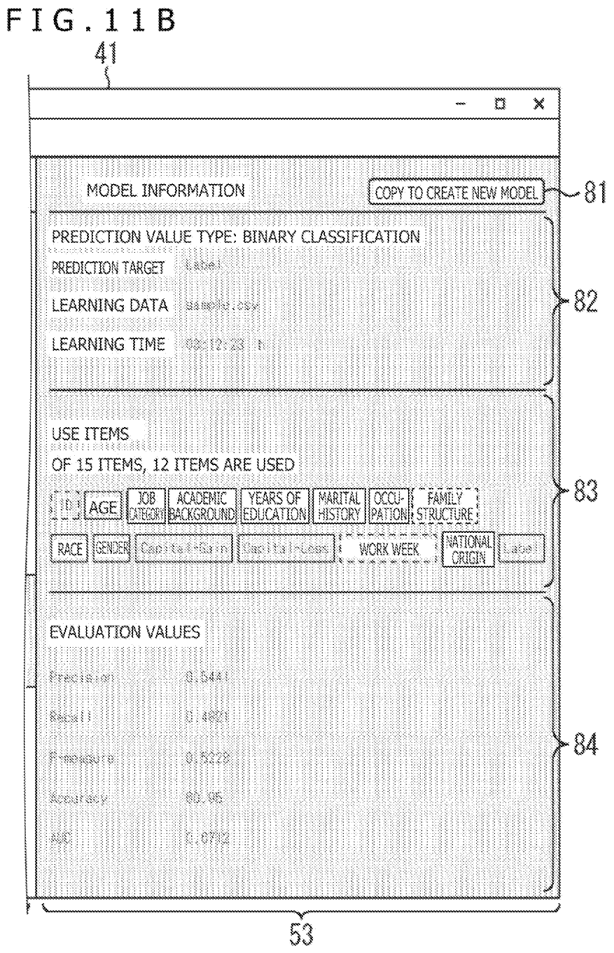

FIG. 11 is a view depicting another configuration example of the history management screen indicated in FIG. 3.

The history management screen 41 of FIG. 11 further includes further two entries 66-4 and 66-5 in addition to the history management screen 41 in FIG. 3.

On the history management screen 41 in FIG. 11, the history display region 65 displays the entry 66-5 having the highest prediction accuracy and the entry 66-4 having the second-highest prediction accuracy, their prediction accuracy being indicated by evaluation values enclosed in a frame (rectangle) each.

The frames enclosing the prediction accuracy evaluation values indicate that there is no statistically significant difference between the entry 66-5 with the highest prediction accuracy and the entry 66-4 with the second-highest prediction accuracy. Thus, in the case where there are entries 66 that are not significantly different statistically from the entry 66 with the highest prediction accuracy, the evaluation values of the prediction accuracy of these entries with no statistically significant difference are highlighted in display in a manner similar to that of the entry 66 with the highest prediction accuracy. Incidentally, the method of highlighting the absence of statistically significant difference is not limited to the framed display depicted in FIG. 11. As an alternative, the same color may be used to highlight any entry 66 with no statistically significant difference, the color being different from the colors in which to display the prediction accuracy evaluation values of the other entries 66.

To determine whether or not there is a statistically significant difference between multiple entries 66 requires that the evaluation value of each entry 66 be calculated multiple times and that a mean value and a standard deviation of the multiple evaluation values of each entry 66 be further calculated beforehand. In the case where the evaluation values of entries 66 have been calculated multiple times and are ready for use in calculating mean values and standard deviations, the learning history management section 23 calculates and stores a mean value and a standard deviation of the evaluation values of each entry 66 in advance. Then, in the case where the entries are displayed in descending order of prediction accuracy evaluation values in the history display region 65, the learning history management section 23 determines whether or not there is a statistically significant difference between the entry 66 having the highest prediction accuracy and the entry 66 having the second-highest prediction accuracy. In the case where it is determined that the entry 66 with the second-highest prediction accuracy is not significantly different statistically from the entry 66 with the highest prediction accuracy, the learning history management section 23 proceeds to determine whether or not there is a statistically significant difference between the entry 66 having the highest prediction accuracy and the entry 66 having the third-highest prediction accuracy. The learning history management section 23 continues to determine whether or not there exists a statistically significant difference between the entry 66 with the highest prediction accuracy and the entry 66 with the next-highest prediction accuracy, until the entry 66 with a statistically significant difference from the entry 66 with the highest prediction accuracy is detected. Alternatively, in the case where the history display region 65 on the history management screen 41 displays entries 66 in descending order of prediction accuracy evaluation values, the moment the entry 66 having the highest prediction accuracy is definitively determined, a determination may be made to see whether or not there is a statistically significant difference between the entry 66 with the highest prediction accuracy and the entry 66 with the next-highest prediction accuracy.

In this manner, when the learning history management section 23 displays whether or not there exists a statistically significant difference between the entry 66 having the highest prediction accuracy on one hand and the other entries on the other hand, the user is able to recognize and compare multiple entries 66 with no statistically significant difference therebetween.

### <7. Example of Entry Differential Display>

The learning history management section 23 has an entry differential display function for displaying differentials in model information between prediction models corresponding to two entries 66 so as to easily compare the two prediction models.

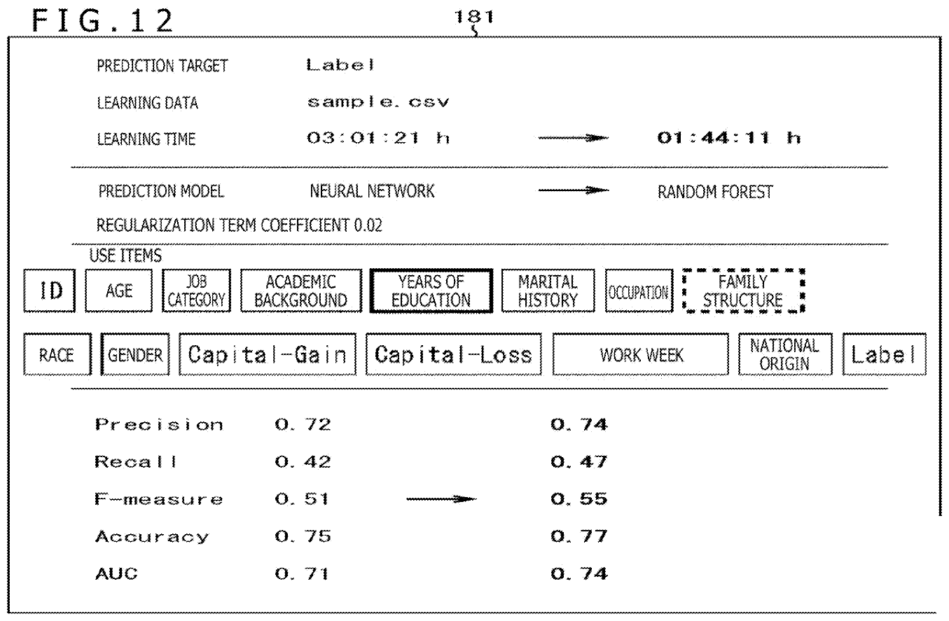

For example, given multiple entries 66 displayed in the entry display region 52 on the history management screen 41 in FIG. 3, the user selects two entries 66 while pressing the control button, for example, and selects “Differential entry” from a menu displayed by right-clicking the mouse. This causes the learning history management section 23 to display an entry differential display screen in FIG. 12. Alternatively, given multiple nodes 161 displayed in the entry display region 52 on the history management screen 41 in FIG. 9, the user may select two nodes 161 while pressing the control button, for example, and select “Differential entry” from the menu displayed by right-clicking the mouse. This can also cause the entry differential display screen in FIG. 12 to be displayed.

FIG. 12 depicts a configuration example of the entry differential display screen.

The entry differential display screen highlights the items that are different between the selected two entries 66 for easy recognition of the different items. The items to be examined for differences are the items displayed as the model information in the summary display region 53 on the history management screen 41 in FIG. 3.

The learning history management section 23 regards one of the two selected entries 66 (e.g., the entry 66 selected earlier) as a differential source entry and the other selected entry 66 (e.g., the entry 66 selected later) as a differential destination entry, and displays the items of the differential source entry on the left on an entry differential display screen 181 in FIG. 12. In the case where the differential destination entry has items that differ from those of the differential source entry, the differing items are indicated by arrows placed to their right, the arrows pointing to specific values of the differing items in the differential destination entry.

In the example of the entry differential display screen 181 in FIG. 12, it is indicated that the learning time, prediction model type, data use items, Precision, Recall, F-measure, Accuracy, and AUC are different between the differential source entry and the differential destination entry.

Specifically, it is indicated that the learning time is “03:01:21 h” for the differential source entry and “01:44:11 h” for the differential destination entry. It is indicated that the prediction model type is “neural network” for the differential source entry and “random forest” for the differential destination entry.

Of the data use items, those present in the differential source entry and absent in the differential destination entry are indicated by thick solid lines, and those items absent in the differential source entry and present in the differential destination entry are indicated by thick dashed lines. Specifically, it is indicated that the data item “years of education” is present in the differential source entry and absent in the differential destination entry and that the data item “family structure” is absent in the differential source entry and present in the differential destination entry.

With regard to the evaluation values of prediction accuracy, it is indicated that Precision, Recall, F-measure, Accuracy, and AUC are “0.72,” “0.42,” “0.51,” “0.75,” and “0.71” respectively for the differential source entry, and “0.74,” “0.47,” “0.55,” “0.77,” and “0.74” respectively for the differential destination entry.

In comparing the evaluation values, an improvement and a deterioration of the differential destination entry with respect to the differential source entry may be indicated in different colors for easy recognition, the improvement being displayed in red and the deterioration in blue, for example.

The entry differential display function for displaying the entry differential display screen 181 in FIG. 12 thus allows the user to easily compare and examine the differences between two desired entries 66.

### <8. Display Example of the Suggest Function>

The learning history management section 23 has a suggest function which, given a chosen entry 66, suggests the learning settings expected to improve the prediction accuracy of the chosen entry 66 (i.e., selected entry). The suggest function is executed by selecting, with the mouse, for example, one of the entries 66 or the nodes 161 displayed in the entry display region 52 on the history management screen 41 in FIG. 3 or in FIG. 9 and by either pressing the suggest button 64 or selecting “Suggest” from the menu displayed by right-clicking the mouse.

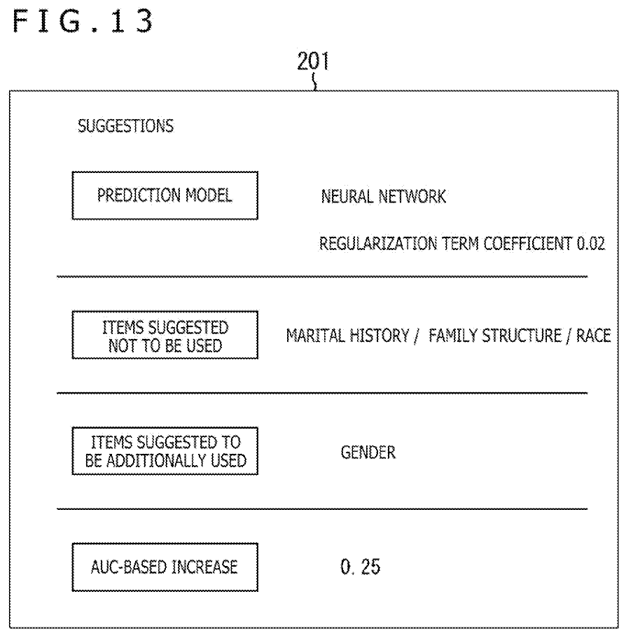

FIG. 13 depicts an example of a suggestion screen displayed in the case where the suggest function is executed.

Explained in the ensuing paragraphs regarding the suggest function is a case where the prediction value type of the prediction model is binary classification.

A suggestion screen 201 in FIG. 13 displays learning settings expected to improve the prediction accuracy of the prediction model type, of the items suggested to be not used, and of the items suggested to be additionally used, over those of the selected entry. The suggestion screen 201 further displays an amount of increase in evaluation value as the extent to which the prediction accuracy is expected to be improved. In the example of FIG. 13, AUC is displayed as the evaluation index. Alternatively, some other suitable evaluation index may be displayed instead.

The suggestion screen 201 in FIG. 13 indicates that the learning history management section 23 suggests setting the prediction model type to “neural network” and the normalization item coefficient to “0.02” regarding the prediction model.

It is also indicated that the learning history management section 23 suggests that, of the data items used in the selected entry, “marital history,” “family structure,” and “race” are the data items preferably not to be used.

It is further indicated that the learning history management section 23 suggests that the data item “gender” is to be preferably added to the data items used in the selected entry.

It is also indicated that the learning history management section 23 suggests that the evaluation value of AUC will be increased by 0.25 if the above-stated prediction model changes are made.

Explained below with reference to the flowchart in FIG. 14 is a suggestion displaying process of displaying suggestions such as those on the suggestion screen 201 in FIG. 13. This process is carried out by pressing the suggest button 64 or by selecting “Suggest” from the menu displayed by right-clicking the mouse after selection of a given entry 66.

First in step S71, the learning history management section 23 selects two entries 66 out of all the entries 66 included in the current project “Project A” so as to form a pair of entries 66, thereby creating a differential entry.

The learning history management section 23 creates the differential entry as follows:

First, of the paired entries 66 thus created, one with the lower evaluation value of prediction accuracy is determined as the differential source entry, and the other entry with the higher evaluation value is determined as the differential destination entry.

The prediction model type and the regularization term coefficient of the differential source entry and those of the differential destination entry are registered in the differential entry. The items used in the differential source entry but not used in the differential destination entry are registered as the unused items in the differential entry. Also, the items not used in the differential source entry but used in the differential destination entry are registered as the additionally used items in the differential entry. Further, the amount of increase in prediction accuracy evaluation value from the differential source entry to the differential destination entry is calculated and registered in the differential entry.

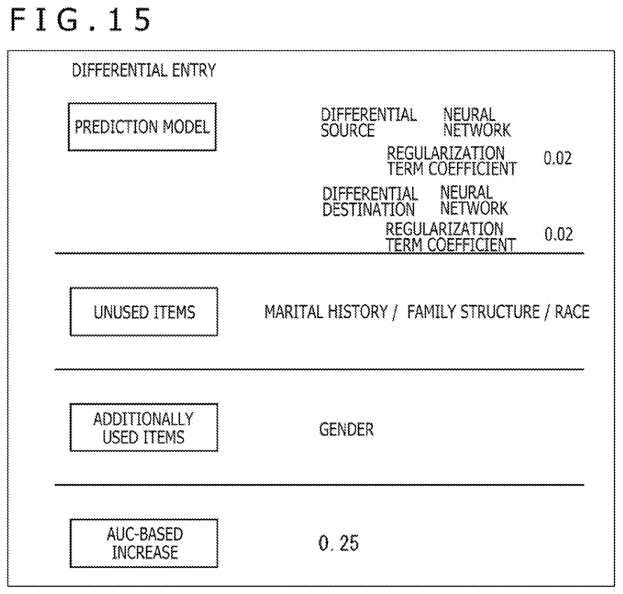

FIG. 15 depicts a typical differential entry created from a given pair of entries 66.

The prediction model type is “neural network” and the regularization term coefficient is “0.02” for both the differential source entry and the differential destination entry in the differential entry of FIG. 15. In the differential entry, the unused items are “marital history,” “family structure,” and “race,” the additionally used item is “gender,” and the AUC-based increase is “0.25.”

Returning to the flowchart of FIG. 14, after step S71, control is transferred to step S72. The learning history management section 23 determines whether the differential entries are created of all paired entries 66 included in the current project “Project A.”

In the case where it is determined in step S72 that the differential entries are not created yet of all paired entries 66, control is returned to step S71, and another differential entry is created.

In the case where it is determined that the differential entries are created of all paired entries 66 after an appropriate number of iterations of the processing in steps S71 and S72, control is transferred to step S73.

In step S73, the learning history management section 23 selects one of the created multiple differential entries, and goes to step S74.

In step S74, the learning history management section 23 determines whether the prediction model type of the differential source in the selected differential entry matches the prediction model type of the selected entry. Here, the selected entry refers to the entry 66 selected by the user before the suggest button 64 is pressed or before “Suggest” is selected from the menu displayed by right-clicking the mouse.

In the case where it is determined in step S74 that the prediction model type of the differential source in the selected differential entry matches the prediction model type of the selected entry, control is transferred to step S75. The learning history management section 23 then sets the selected differential entry as a suggestion candidate constituting a suggested differential entry candidate, and goes to step S78.

On the other hand, in the case where it is determined in step S74 that the prediction model type of the differential source in the selected differential entry does not match the prediction model type of the selected entry, control is transferred to step S76. The learning history management section 23 then determines whether the unused items in the selected differential entry are used in the selected entry.

In the case where it is determined in step S76 that the unused items in the selected differential entry are used in the selected entry, control is transferred to step S75. The learning history management section 23 then sets the selected differential entry as a suggestion candidate constituting a suggested differential entry candidate, and goes to step S78.

On the other hand, in the case where it is determined in step S76 that the unused items in the selected differential entry are not used in the selected entry, control is transferred to step S77. The learning history management section 23 then determines whether the additionally used items in the selected differential entry are used in the selected entry.

In the case where it is determined in step S77 that the additionally used items in the selected differential entry are used in the selected entry, control is transferred to step S75.

The learning history management section 23 then sets the selected differential entry as a suggestion candidate constituting a suggested differential entry candidate, and goes to step S78.

On the other hand, in the case where it is determined in step S77 that the additionally used items in the selected differential entry are not used in the selected entry, control is transferred to step S78.

Thus, in the case where at least one of the following conditions (1) to (3) holds as a result of the processing in steps S74 to S77, the learning history management section 23 sets the currently selected differential entry as a suggestion candidate:

(1) The prediction model type of the differential source in the selected differential entry matches the prediction model type in the selected entry.
(2) The unused items in the selected differential entry are used in the selected entry.
(3) The additionally used items in the selected differential entry are used in the selected entry.

Then in step S78, the learning history management section 23 determines whether all created differential entries have been selected. In the case where it is determined in step S78 that not all differential entries have been selected yet, control is returned to step S73, and another differential entry is selected. The above-described steps S74 to S78 are then repeated.

On the other hand, in the case where it is determined in step S78 that all created differential entries have been selected, control is transferred to step S79. The learning history management section 23 then determines as the suggested differential entry the differential entry having the largest AUC-based increase from among the differential entries set as the suggestion candidates. The learning history management section 23 generates the suggestion screen 201 such as one in FIG. 13, causes the generated suggestion screen 201 to be displayed, and terminates the suggestion displaying process.

As described above, the suggestion displaying process involves creating the differential entries out of all entries 66 included in the current project and analyzing the differentials between the paired entries so as to display the learning settings expected to improve the prediction accuracy over that of the selected entry.

In the case where the condition (1) above holds following the determinations in steps S74 to S77, a prediction model field on the suggestion screen 201 in FIG. 13 displays the prediction model type and the regularization term coefficient of the differential destination entry in the suggested differential entry.

In the case where the condition (2) above holds following the determinations in steps S74 to S77, an items-suggested-not-to-be-used field on the suggestion screen 201 in FIG. 13 displays the data items suggested not to be used in the suggested differential entry.

In the case where the condition (3) above holds following the determinations in steps S74 to S77, an items-suggested-to-be-additionally-used field on the suggestion screen 201 in FIG. 13 displays the data items suggested to be additionally used in the suggested differential entry.

Also, an AUC-based increase field on the suggestion screen 201 in FIG. 13 displays the AUC-based increase of the suggested differential entry. Alternatively, the AUC-based increase item may be omitted.

The above-described suggest function of the learning history management section 23 allows the user to find more easily and more quickly the learning settings for increasing the evaluation value (AUC).

### <9. Configuration Example of the Computer>

The series of processes described above can be executed either by hardware or by software. In a case where the series of processing is to be carried out by software, the programs constituting the software are installed into a suitable computer. Variations of the computer include a microcomputer incorporated beforehand in its dedicated hardware, and a general-purpose personal computer or like equipment capable of executing diverse functions based on the various kinds of programs installed therein.

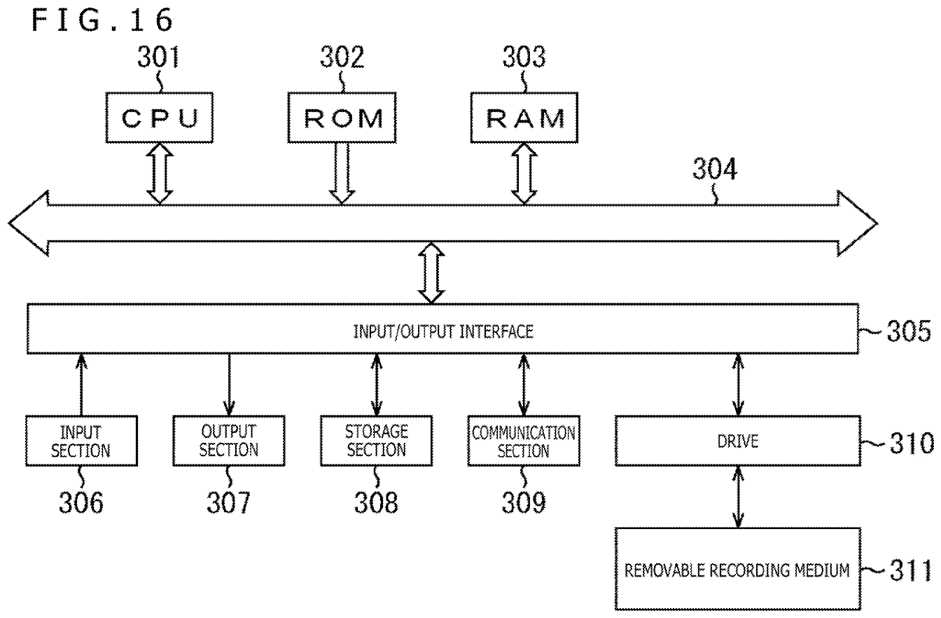

FIG. 16 is a block diagram depicting a hardware configuration example of a computer that executes the above-described series of processing using programs.

In the computer, a CPU (Central Processing Unit) 301, a ROM (Read Only Memory) 302, and a RAM (Random Access Memory) 303 are interconnected via a bus 304.

The bus 304 is further connected with an input/output interface 305. The input/output interface 305 is connected with an input section 306, an output section 307, a storage section 308, a communication section 309, and a drive 310.

The input section 306 typically includes a keyboard, a mouse, a microphone, a touch panel, and input terminals. The output section 307 typically includes a display, speakers, and output terminals. The storage section 308 typically includes a hard disk, a RAM disk, and a nonvolatile memory. The communication section 309 typically includes a network interface. The drive 310 drives a removable recording medium 311 such as a magnetic disc, an optical disc, a magneto-optical disc, or a semiconductor memory.

In the computer configured as described above, the CPU 301 performs the above-mentioned series of processing by loading the appropriate programs from the storage section 308 into the RAM 303 via the input/output interface 305 and the bus 304 and by executing the loaded programs. The RAM 303 may also store data needed by the CPU 301 in carrying out diverse processes as required.

The programs to be executed by the computer (CPU 301) can be recorded, for example, on the removable recording medium 311 as a packaged medium when offered. The programs can also be offered via a wired or wireless transmission medium such as local area networks, the Internet, and digital satellite broadcasting.

In the computer, the programs can be installed into the storage section 308 from the removable recording medium 311 attached to the drive 310 via the input/output interface 305. The programs can also be installed into the storage section 308 after being received by the communication section 309 via a wired or wireless transmission medium. The programs can alternatively be preinstalled in the ROM 302 or in the storage section 308.

In this description, the steps described in the flowcharts may be executed by the computer chronologically in the depicted sequence, in parallel with each other, or in otherwise appropriately timed fashion such as when the steps are invoked as needed.

It is to be noted that, in this description, the term “system” refers to an aggregate of multiple components (e.g., apparatuses or modules (parts)). It does not matter whether or not all components are housed in the same enclosure. Thus, a system may include multiple apparatuses housed in separate enclosures and interconnected via a network, or with a single apparatus in a single enclosure that houses multiple modules.

The present technology is not limited to the preferred embodiments discussed above and may be implemented in diverse variations so far as they are within the scope of this technology.

For example, part or all of the multiple embodiments discussed above can be combined suitably to devise other embodiments.

For example, the present technology can be implemented as a cloud computing setup in which a single function is processed cooperatively by multiple networked apparatuses on a shared basis.

Also, each of the steps discussed in reference to the above-described flowcharts can be executed either by a single apparatus or by multiple apparatuses on a shared basis.

Further, in the case where a single step includes multiple processes, these processes can be executed either by a single apparatus or by multiple apparatuses on a shared basis.

The advantageous effects stated in this description are only examples and not limitative of the present technology that may also provide other advantages.

The present technology can also be configured preferably as follows:

(1)

An information processing apparatus including:

a control section configured to perform control to display a plurality of prediction models as models trained by machine learning, and respective pieces of model information regarding the prediction models.

(2)

The information processing apparatus as stated in paragraph (1) above, in which the control section sorts the plurality of prediction models in descending order of prediction accuracy.

(3)

The information processing apparatus as stated in paragraph (2) above, in which the control section forms a group of the plurality of prediction models having the same prediction value type constituting a type of prediction values of the grouped prediction models and the same prediction target constituting a data item predicted by the grouped prediction models and, in each group, sorts and displays the plurality of prediction models in descending order of prediction accuracy.

(4)

The information processing apparatus as stated in paragraph (3) above, in which the control section connects and displays the sorted prediction models in each group in order of the groups having decreasing numbers of the prediction models.

(5)

The information processing apparatus as stated in paragraph (3) or (4) above, in which the control section performs a comparability determining process of determining whether or not two of the formed groups are comparable with each other.

(6)

The information processing apparatus as stated in paragraph (5) above in which, in a case where the two groups are determined to have the same prediction target in the comparability determining process, the control section determines that the two groups are comparable with each other.

(7)

The information processing apparatus as stated in paragraph (5) or (6) above in which, in a case where a differential between mean values of statistics of the two groups is determined to be equal to or less than a predetermined value in the comparability determining process, the control section determines that the two groups are comparable with each other.

(8)

The information processing apparatus as stated in any one of paragraphs (5) to (7) above in which, in a case where a common portion is determined to exist between possible values that are capable of being taken by the two groups of which the prediction target is categorical, the control section determines that the two groups are comparable with each other.

(9)

The information processing apparatus as stated in any one of paragraphs (1) to (8) above, in which the control section performs control to display the plurality of prediction models in a tree representation.

(10)

The information processing apparatus as stated in paragraph (9) above, in which the control section provides display in a tree representation such that a distinction is made between the prediction model created by copying any of the prediction models and the prediction model created without making the copy.

(11)

The information processing apparatus as stated in any one of paragraphs (1) to (10) above, in which the control section further provides display indicating whether or not there is a statistically significant difference between the prediction model having a highest prediction accuracy and any other prediction model.

(12)

The information processing apparatus as stated in any one of paragraphs (1) to (11) above, in which the control section further performs control to display a differential in the model information between the two prediction models.

(13)

The information processing apparatus as stated in any one of paragraphs (1) to (12) above, in which the control section further performs control to analyze a differential in the model information between the two prediction models so as to display a learning setting expected to improve prediction accuracy.

(14)

The information processing apparatus as stated in paragraph (13) above, in which the control section displays a prediction model of which the prediction accuracy is expected to be improved over a prediction model selected from among the plurality of prediction models.

(15)

The information processing apparatus as stated in paragraph (13) or (14) above, in which the control section displays a prediction model type as the learning setting.

(16)

The information processing apparatus as stated in paragraph (14) or (15) above, in which the control section displays, as the learning setting, a data item preferably not to be used by the selected prediction model.

(17)

The information processing apparatus as stated in any one of paragraphs (14) to (16) above, in which the control section displays, as the learning setting, a data item preferably to be added to the selected prediction model.

(18)

An information processing method including:

causing an information processing apparatus to perform control to display a plurality of prediction models as models trained by machine learning, and respective pieces of model information regarding the prediction models.

(19)

A program for causing a computer to function as:

a control section performing control to display a plurality of prediction models as models trained by machine learning, and respective pieces of model information regarding the prediction models.

### REFERENCE SIGNS LIST

1 Prediction system
11 Prediction application
14 Display
21 Learning section
22 Prediction section
23 Learning history management section
41 History management screen
62 Sort button
63 Display-tree button
64 Suggest button
181 Entry differential display screen
201 Suggestion screen
301 CPU
302 ROM
303 RAM
306 Input section
307 Output section
308 Storage section
309 Communication section
310 Drive

1. An information processing apparatus comprising:
a control section configured to perform control to display a plurality of prediction models as models trained by machine learning, and respective pieces of model information regarding the prediction models.

2. The information processing apparatus according to claim 1, wherein the control section sorts the plurality of prediction models in descending order of prediction accuracy.

3. The information processing apparatus according to claim 2, wherein the control section forms a group of the plurality of prediction models having a same prediction value type constituting a type of prediction values of the grouped prediction models and a same prediction target constituting a data item predicted by the grouped prediction models and, in each group, sorts and displays the plurality of prediction models in descending order of prediction accuracy.

4. The information processing apparatus according to claim 3, wherein the control section connects and displays the sorted prediction models in each group in order of the groups having decreasing numbers of the prediction models.

5. The information processing apparatus according to claim 3, wherein the control section performs a comparability determining process of determining whether or not two of the formed groups are comparable with each other.

6. The information processing apparatus according to claim 5, wherein, in a case where the two groups are determined to have a same prediction target in the comparability determining process, the control section determines that the two groups are comparable with each other.

7. The information processing apparatus according to claim 5, wherein, in a case where a differential between mean values of statistics of the two groups is determined to be equal to or less than a predetermined value in the comparability determining process, the control section determines that the two groups are comparable with each other.

8. The information processing apparatus according to claim 5, wherein, in a case where a common portion is determined to exist between possible values that are capable of being taken by the two groups of which the prediction target is categorical, the control section determines that the two groups are comparable with each other.

9. The information processing apparatus according to claim 1, wherein the control section further performs control to display the plurality of prediction models in a tree representation.

10. The information processing apparatus according to claim 9, wherein the control section provides display in a tree representation such that a distinction is made between the prediction model created by copying any of the prediction models and the prediction model created without making the copy.

11. The information processing apparatus according to claim 1, wherein the control section further provides display indicating whether or not there is a statistically significant difference between the prediction model having a highest prediction accuracy and any other prediction model.

12. The information processing apparatus according to claim 1, wherein the control section further performs control to display a differential in the model information between the two prediction models.

13. The information processing apparatus according to claim 1, wherein the control section further performs control to analyze a differential in the model information between the two prediction models so as to display a learning setting expected to improve prediction accuracy.

14. The information processing apparatus according to claim 13, wherein the control section displays a prediction model of which the prediction accuracy is expected to be improved over a prediction model selected from among the plurality of prediction models.

15. The information processing apparatus according to claim 13, wherein the control section displays a prediction model type as the learning setting.

16. The information processing apparatus according to claim 14, wherein the control section displays, as the learning setting, a data item preferably not to be used by the selected prediction model.

17. The information processing apparatus according to claim 14, wherein the control section displays, as the learning setting, a data item preferably to be added to the selected prediction model.

18. An information processing method comprising:
causing an information processing apparatus to perform control to display a plurality of prediction models as models trained by machine learning, and respective pieces of model information regarding the prediction models.

19. A program for causing a computer to function as:
a control section performing control to display a plurality of prediction models as models trained by machine learning, and respective pieces of model information regarding the prediction models.
